(19) United States
(12) Patent Application Publication
(10) Pub. No.: US 2003/0087014 A1
(43) Pub. Date: May 8, 2003

(54) Enhanced thermal inactivation of pathogen in a nutriment by acidulant

(75) Inventors: Maurice Clarence Kemp, El Dorado Hills, CA (US); Robert H. Carpenter, Bastrop, TX (US); Michael Patrick Doyle, Peachtree City, GA (US); Robert Blaine Lalum, Citrus Heights, CA (US); Zhong Wei Xie, Folsom, CA (US); Yao Yu, Roseville, CA (US); Tong Zhao, Peachtree City, GA (US)

Correspondence Address: JACKSON WALKER LLP, 2435 NORTH CENTRAL EXPRESSWAY, SUITE 600, RICHARDSON, TX, 75080, US

(73) Assignee: Mionix Corp., Roseville, CA

(21) Appl. No.: 09/918,096

(22) Filed: Jul. 30, 2001

(51) Int. Cl. C12H 1/10

(52) U.S. Cl. 426/321

(57) ABSTRACT

A method for increasing the rate of thermal inactivation of a pathogen in a nutriment by contacting the nutriment with an acidulant. A method for extending case shelf-life of a nutriment by contacting the nutriment with an acidulant. The acidulant can be: (a) an acidic, or low pH, solution of sparingly-soluble Group IIA complexes (“AGIIS”); (b) a highly acidic metalated mixture of inorganic acid (“HAMMIA”); (c) a highly acidic metalated organic acid (“HAMO”); (d) a mixture of the above; or (e) an adduct of each of the above. The nutriment can be an animal product, a plant product, a beverage, or a mixture thereof.

### BACKGROUND

The present invention relates to a method to decontaminate and detoxify a nutriment. More specifically, the present invention relates to a method for using an acidulant to increase the rate of thermal inactivation of a food borne pathogen and/or its potential toxins in a nutriment such as food, drink, and feed.

Microorganisms, particularly bacteria, can be found almost everywhere. They are present in the air, water and soil; they can grow wherever higher organisms can grow, and can be found on the surfaces of plants and animals as well as in the mouth, nose and intestines of animals, including humans. They also occur in places that are far too inhospitable for higher life forms, such as in hot sulfur springs. As a result, foods are hardly ever sterile, that is to say completely free from viable microorganisms. The viable microorganisms may include food borne pathogens. Foods carry a mixed population of microorganisms derived from the natural microflora of the original plant or animal, those picked up from its environment and those introduced during harvest/slaughter and subsequent handling, processing and storage.

Most of the microorganisms in our environment cause us no harm. In fact they play very useful roles in making soil fertile and decomposing and recycling organic and inorganic materials that would otherwise accumulate. When they occur in foods, many of these organisms have no evident effect on the food or the animal or person consuming it. In some cases, microorganisms may actually produce beneficial changes in the food and this is the basis of the large range of fermented foods such as cheese, yogurt, and fermented meats. Others, however, will spoil the product making it unfit for consumption and some can be harmful to humans causing illness when they or the toxins they produce are ingested.

Since the mid 1980's enterohemorrhagic Escherichia coli (EHEC) O157:H7, sometimes referred to as E. coli, has been a major food borne pathogen, causing an estimated 73,000 cases of infection, 61 deaths, and 21,000 hospitalizations to date in the United States. Infections have been reported in more than 30 countries on six continents, and ground beef is a major source of the infection. The organism can live in the gastrointestinal tract of healthy cattle, and can contaminate beef products during slaughter. The infection can be spread by contact with contaminated objects and by ingestion of contaminated food and water, and is particularly virulent where hygiene is substandard. EHEC infection can cause hemorrhagic colitis with symptoms of bloody diarrhea and abdominal cramps. In young children and the elderly, the infection can progress into a more severe, life-threatening complication known as hemolytic uremic syndrome (HUS), in which the red blood cells are destroyed and the kidneys fail. In the United States HUS is the principal cause of acute kidney failure in children, and most cases of HUS are caused by EHEC. About one-third of HUS sufferers have abnormal kidney function, and a few require long-term dialysis. Another 8% of HUS sufferers have other lifelong complications, such as high blood pressure, seizures, blindness, paralysis, and the effects of having part of their bowel removed. Technical Information Bulletin, The Centers for Disease Control and Prevention, http://www.cdc.gov/ncidod/dbmd/diseaseinfo/escherichiacoli_g.htm; J. Food Protection, vol. 57, pages 198-203 (1994).

Application of heat kills EHEC in ground meat. Therefore, the Centers for Disease Control and Prevention (CDC) recommends achievement of uniformly high temperature, monitored with a meat thermometer, throughout ground beef during cooking. In spite of such recommendations, EHEC infections persist, partly because many do not realize that cooking can cause ground beef to turn brown before EHEC is killed. Therefore, it is desirable to decrease EHEC heat tolerance.

“D value” is a value useful in determining rates of inactivation of microorganisms to a treatment such as ethylene oxide (“EO”) or a saturated steam under pressure. The “D value” is defined as the time required to reduce a microbial population by 1 log, or 90%, of its initial value under specified conditions (e.g. sterilant concentration, exposure temperature, relative humidity, etc.).

Thermal destruction of microorganisms such as EHEC generally obey first-order reaction kinetics. For any initial concentration in a specific environment, if the concentration diminishes×% in time interval t, the concentration at time t will diminish×% in the subsequent time interval t, and so on. Since the time rate of change of the microorganism's concentration dc/dt is constant, it integrates to the logarithmic function

T=(ln c₀−ln c₁)/k (1)

T=2.303(log c₀−log c₁)/k

D=2.303/k (2)

where

T=biologic indicator exposure time

c₁=biologic indicator concentration at time T

c₀=initial biologic indicator concentration

k=first-order reaction rate constant

D=time required for the biologic indicator concentration to decrease one log cycle

Eq. (1) describes a straight line on a semi-log graph with a logarithmic concentration ordinate and a linear time abscissa. Since log cycles increment by factors of ten, one cycle represents a 90% change. Thus the time D required to traverse a log cycle, Eq. (2), is the time required to reduce a microorganism concentration by 90%. That time is a generally recognized measure of the effects of a treatment on a biological indicator, and has been called the decimal reduction time, or D-value. Karel et al., Principles of Food Science, Part II, 39-40 (1975).

Many attempts to kill EHEC or weaken its heat tolerance have focused on acids. Acidic foods with pH less than 4.6 are generally regarded as low risk in terms of food safety. See U.S. Food and Drug Administration Retail Food Store Sanitation Code. However, outbreaks of serotype O157:H7 and several laboratory studies have demonstrated that the pathogen can tolerate acidic environments such as apple cider and other media with pH as low as 2.0 under ambient conditions. Besser et al., An Outbreak of Diarrhea and Hemolytic Uremic Syndrome from Escherichia coli O157:H7 in Fresh-Pressed Apple Cider, JAMA, 1993;269:2217-20; Miller et al., Escherichia coli O157:H7 Acid Tolerance and Survival in Apple Cider, J. Food Prot., 1994;57:460-4; Zhao et al., Fate of Enterohemorrhagic Escherichia coli O157:H7 in Apple Cider with and without Preservatives, Appl. Environ. Microbiol 1993;59:2526-30.

Also, studies specific to cattle carcasses and beef products have shown acid treatment to be ineffective for EHEC decontamination. Williams et al., Thermotolerance of Escherichia coli O157:H7 ATCC 43894, Escherichia coli B, and an rpoS-Deficient Mutant of Escherichia coli O157:H7 ATCC 43895 Following Exposure to 1.5% Acetic Acid, J. Food Prot., 1998;61:1184-86; Brackett et al., Ineffectiveness of Hot Acid Sprays to Decontaminate Escherichia coli O157:H7 on Beef, J. Food Prot., 1994;57:198-203.

Although heat will inactivate a food borne pathogen, it is desirable to reduce the degree of heat processing given to a nutriment so that the sensory properties and nutritional value of the nutriment are not affected. Further, by increasing the rate of thermal inactivation of a pathogen in a nutriment will also result in cost savings.

### BRIEF DESCRIPTION OF DRAWINGS

FIGS. 1-3 show the determination of D-values of E. coli 0157:H7 in ground beef under the influence of an adduct from an acidulant (ADDT)—pre-freezing the ground beef, heating the ground beef, and the combination of the two.

FIG. 1 shows the inactivation of E. coli 0157:H7 (OH1395) in ground beef by the effect of ADDT and heating to 57° C.;

FIG. 2 shows the inactivation of E. coli 0157:H7 (OH1395) in ground beef by the effect of ADDT and heating to 60° C.;

FIG. 3 shows the inactivation of E. coli 0157:H7 (OH1395) in ground beef by the effect of ADDT and heating to 62.8° C.;

FIG. 4 shows the effect of acidulant on E. coli 0157:H7 in ground beef during cooking at different temperatures; and

FIG. 5 shows the effect of acidulant on E. coli 0157:H7 in ground beef during cooking at different temperatures.

### SUMMARY AND DETAILED DESCRIPTION

Broadly, one aspect of the present invention involves a method for increasing the rate of thermal inactivation of a pathogen in a nutriment by contacting the nutriment with an acidulant. The acidulant can be: (a) an acidic, or low pH, solution of sparingly-soluble Group IIA complexes (“AGIIS”); (b) a highly acidic metalated mixture of inorganic acid (“HAMMIA”); (c) a highly acidic metalated organic acid (“HAMO”); (d) a mixture of the above; or (e) an adduct of each of the above. The acidulant can be first mixed with a carrier, commonly used in food, feed, or drink, to give a constituted carrier before mixing the constituted carrier with the nutriment. The nutriment can be an animal product, a plant product, a beverage, or a mixture thereof.

The present invention offers a method by which the heat tolerance of a food borne pathogen can be reduced, thereby reducing the time for a significant portion of the food borne pathogen and/or its potential toxins to be destroyed or inactivated by exposure to heat. The present invention discloses a method whereby the D-value of food contaminants can be significantly reduced and the rate of thermal inactivation of a food borne pathogen can be increased.

Another embodiment of the present invention involves a method for extending the “case shelf-life” of a nutriment (at a temperature below ambient temperature) by contacting the nutriment with an acidulant.

One acidulant of the present invention involves a highly acidic metalated mixture of inorganic acids (“HAMMIA”). See, “Highly Acidic Metalated Inorganic Acid Mixture,” U.S. application Ser. No. 09/873,755, filed Jun. 4, 2001, the entire content of which is hereby incorporated by reference. The composition has an acidic pH, and can be isolated from a mixture prepared by mixing ingredients comprising a salt of phosphoric acid, and a preformed, or in-situ generated, solution or suspension of an acidic sparingly-soluble Group IIA complex (“AGIIS”), another acidulant of the present invention wherein the solution or suspension of AGIIS is in an amount sufficient to render the acidic pH of the composition to be less than about 2. Another embodiment of the present invention involves a composition having an acidic pH, the composition is isolated from a mixture prepared by mixing ingredients comprising a salt of phosphoric acid, and a preformed, or in-situ generated, solution or suspension of AGIIS, wherein the solution or suspension of AGIIS is in an amount in excess of the amount required to completely convert the salt of phosphoric acid to phosphoric acid. Still another embodiment of the present invention involves an adduct which contains an additive and the acidic composition of the present invention. Other aspects of the present invention pertain to a prepared nutriment containing a nutriment material and absorbed therein or adsorbed thereon is the acidic composition or the adduct of the present invention. Another aspect of the present invention involves a method to reduce biological contaminants in a nutriment material.

The acidic or low pH, solution of sparingly-soluble Group IIA complexes (“AGIIS”) may have a suspension of very fine particles and the term “low pH” means the pH is below 7, in the acidic region. The AGIIS has a certain acid normality but does not have the same dehydrating behavior as a saturated calcium sulfate in sulfuric acid having the same normality. In other words, the AGIIS has a certain acid normality but does not char sucrose as readily as does a saturated solution of calcium sulfate in sulfuric acid having the same normality. Further, the AGIIS has low volatility at room temperature and pressure. It is less corrosive to a human skin than sulfuric acid saturated with calcium sulfate having the same acid normality. Not intending to be bound by the theory, it is believed that one embodiment of AGIIS comprises near-saturated, saturated, or super-saturated calcium, sulfate anions or variations thereof, and/or complex ions containing calcium, sulfates, and/or variations thereof.

The term “complex,” as used herein, denotes a composition wherein individual constituents are associated. “Associated” means constituents are bound to one another either covalently or non-covalently, the latter as a result of hydrogen bonding or other inter-molecular forces. The constituents may be present in ionic, non-ionic, hydrated or other forms.

The AGIIS can be prepared in several ways. Some of the methods involve the use of Group IA hydroxide but some of syntheses are devoid of the use of any added Group IA hydroxide, although it is possible that a small amount of Group IA metal may be present as “impurities.” The preferred way of manufacturing AGIIS is not to add Group IA hydroxide to the mixture. As the phrase implies, AGIIS is highly acidic, ionic, with a pH of below about 7, preferably below about 2. See, “Acidic Solution of Sparingly-Soluble Group IIA Complexes,” U.S. application Ser. No. 09/500,473, filed Feb. 9, 2000, the entire content of which is hereby incorporated by reference. See also, “Highly Acidic Metalated Organic Acid as a Food Additive,” U.S. application Ser. No. 09/766,546, filed Jan. 19, 2001, the entire content of which is hereby incorported by reference.

A preferred method of preparing AGIIS involves mixing a mineral acid with a Group IIA hydroxide, or with a Group IIA salt of a dibasic acid, or with a mixture of the two Group IIA materials. In the mixing, a salt of Group IIA is also formed. Preferably, the starting Group IIA material or materials selected will give rise to, and form, the Group IIA salt or salts that are sparingly soluble in water. The preferred mineral acid is sulfuric acid, the preferred Group IIA hydroxide is calcium hydroxide, and the prefer Group IIA salt of a dibasic acid is calcium sulfate. Other examples of Group IIA salt include calcium oxide, calcium carbonate, and “calcium bicarbonate.”

Thus, for example, AGIIS can be prepared by mixing or blending starting materials given in one of the following scheme with good reproducibility:

(1) H₂SO₄ and Ca(OH)₂;

(2) H₂SO₄, Ca(OH)₂, and CaCO₃;

(3) H₂SO₄, Ca(OH)₂, CaCO₃, and CO₂ (gas);

(4) H₂SO₄, CaCO₃, and Ca(OH)₂;

(5) H₂SO₄, Ca(OH)₂, and CaSO₄;

(6) H₂SO₄, CaSO₄, CaCO₃, and Ca(OH)₂;

(7) H₂SO₄, CaSO₄, CaCO₃, and CO₂ (gas); and

(8) H₂SO₄, CaSO₄, CaCO₃, CO₂ (gas), and Ca(OH)₂.

Preferably, AGIIS is prepared by mixing calcium hydroxide with concentrated sulfuric acid, with or without an optional Group IIA salt of a dibasic acid (such as calcium sulfate) added to the sulfuric acid. The optional calcium sulfate can be added to the concentrated sulfuric acid prior to the introduction of calcium hydroxide into the blending mixture. The addition of calcium sulfate to the concentrated sulfuric acid appears to reduce the amount of calcium hydroxide needed for the preparation of AGIIS. Other optional reactants include calcium carbonate and gaseous carbon dioxide being bubbled into the mixture. Regardless of the use of any optional reactants, it was found that the use of calcium hydroxide is desirable.

One preferred method of preparing AGIIS can be described briefly as: Concentrated sulfuric acid is added to chilled water (8°-12° C.) in the reaction vessel, then, with stirring, calcium sulfate is added to the acid in chilled water to give a mixture. Temperature control is paramount to this process. To this stirring mixture is then added a slurry of calcium hydroxide in water. The solid formed from the mixture is then removed. This method involves the use of sulfuric acid, calcium sulfate, and calcium hydroxide, and it has several unexpected advantages. Firstly, this reaction is not violent and is not exceedingly exothermic. Besides being easy to control and easy to reproduce, this reaction uses ingredients each of which has been reviewed by the U.S. Food and Drug Administration (“U.S. FDA”) and determined to be “Generally Recognized As Safe” (“GRAS”). As such, each of these ingredients can be added directly to food, subject, of course, to certain limitations. Under proper concentration, each of these ingredients can be used as processing aids and in food contact applications. Their use is limited only by product suitability and current Good Manufacturing Practices (“cGMP”). The AGIIS so prepared is thus safe for animal consumption, safe for processing aids, and safe in food contact applications. Further, the AGIIS reduces biological contaminants in not only inhibiting the growth of, and killing, microorganisms but also destroying the toxins formed and generated by the microorganisms. The AGIIS formed can also preserve, or extend the shelf-life of, consumable products, be they plant, animal, pharmaceutical, or biological products. It also preserves or improves the organoleptic quality of a beverage, a plant product or an animal product. It also possesses certain healing and therapeutic properties.

The sulfuric acid used is usually 95-98% FCC Grade (about 35-37 N). The amount of concentrated sulfuric acid can range from about 0.05 M to about 18 M (about 0.1 N to about 36 N), preferably from about 1 M to about 5 M. It is application specific. The term “M” used denotes molar or moles per liter.

Normally, a slurry of finely ground calcium hydroxide suspended in water (about 50% of w/v) is the preferred way of introducing the calcium hydroxide, in increments, into the stirring solution of sulfuric acid, with or without the presence of calcium sulfate. Ordinarily, the reaction is carried out below 40° C., preferably below room temperature, and more preferably below 10° C. The time to add calcium hydroxide can range from about 1 hour to about 4 hours. The agitation speed can vary from about 600 to about 700 rpm or higher. After the mixing, the mixture is filtered through a 5 micron filter. The filtrate is then allowed to sit overnight and the fine sediment is removed by decantation.

The calcium hydroxide used is usually FCC Grade of about 98% purity. For every mole of concentrated acid, such as sulfuric acid, the amount, in mole, of calcium hydroxide used is application specific and ranges from about 0.1 to about 1.

The phosphoric acid used is usually from JT Baker of about 85-88%.

The calcium monohydrogen phosphate is usually of 98-99%; and the calcium phosphate (“the tribasic”) is obtained from Mallinckrodt. Other phosphate salts used are all of reagent grade.

The optional calcium carbonate is normally FCC Grade having a purity of about 98%. When used with calcium hydroxide as described above, for every mole of concentrated acid, such as sulfuric acid, the amount, in mole, of calcium carbonate ranges from about 0.001 to about 0.2, depending on the amount of calcium hydroxide used.

The optional carbon dioxide is usually bubbled into the slurry containing calcium hydroxide at a speed of from about 1 to about 3 pounds pressure. The carbon dioxide is bubbled into the slurry for a period of from about 1 to about 3 hours. The slurry is then added to the reaction vessel containing the concentrated sulfuric acid.

Another optional ingredient is calcium sulfate, a Group IIA salt of a dibasic acid. Normally, dihydrated calcium sulfate is used. As used in this application, the phrase “calcium sulfate,” or the formula “CaSO₄,” means either anhydrous or hydrated calcium sulfate. The purity of calcium sulfate (dihydrate) used is usually 95-98% FCC Grade. The amount of calcium sulfate, in moles per liter of concentrated sulfuric acid ranges from about 0.005 to about 0.15, preferably from about 0.007 to about 0.07, and more preferably from about 0.007 to about 0.04. It is application specific.

In the event that CaSO₄ is used for the reaction by adding it to the solution of concentrated H₂SO₄, the amount of CaSO₄, in grams per liter of solution based on final volume, has the following relationship:

| Final AGIIS Acid Normality N | Amount of CaSO₄ in g/l |
|---|---|
| 1-5 | 5 |
| 6-10 | 4 |
| 11-15 | 3 |
| 16-20 | 2 |
| 21-36 | 1 |

The AGIIS obtained could have an acid normality range of from about 0.05 to about 31; the pH of lower than 0; boiling point of from about 100 to about 106° C.; freezing point of from about −8° C. to about 0° C.

AGIIS obtained from using the reaction of H₂SO₄/Ca(OH)₂/CaSO₄ had the following analyses (average):

AGIIS With Final Acid Normality of 1.2 N, pH of −0.08

H₃O⁺, 2.22%; Ca, 602 ppm; SO₄, 73560 ppm; K, 1.36 ppb; impurities of 19.68 ppm, and neither Na nor Mg was detected.

AGIIS With Final Acid Normality of about 29 N, pH of about −1.46

H₃O⁺, 30.68%; Ca, 52.9 ppm; SO₄, 7356000 ppm; K, 38.02 ppb; and neither Na nor Mg was detected.

Aqueous solutions of other alkalis or bases, such as Group IA hydroxide solution or slurry and Group IIA hydroxide solution or slurry can be used. Groups IA and IIA refer to the two Groups in the periodical table. The use of Group IIA hydroxide is preferred. Preferably, the salts formed from using Group IIA hydroxides in the reaction are sparingly soluble in water. It is also preferable to use only Group IIA hydroxide as the base without the addition of Group IA hydroxide.

After the reaction, the resultant concentrated acidic solution with a relatively low pH value, typically below pH 1, can then be diluted with deionized water to the desired pH value, such as pH of about 1 or about 1.8.

As discussed above, AGIIS has relatively less dehydrating properties (such as charring sucrose) as compared to the saturated solution of CaSO₄ in the same concentration of H₂SO₄. Further, the stability and non-corrosive nature of the AGIIS of the present invention can be illustrated by the fact that a person can put his or her hand into this solution with a pH of less than 0.5 and, yet, his or her hand suffers no irritation, and no injury. If, on the other hand, one places his or her hand into a solution of sulfuric acid of pH of less than 0.5, an irritation would occur within a relatively short span of time. A solution of 28 N of sulfuric acid saturated with calcium sulfate will cause chemical bum to a human skin after a few seconds of contact. In contrast, AGIIS solution of the same normality would not cause chemical bum to a human skin even after in contact for 5 minutes. The AGIIS does not seem to be corrosive when being brought in contact with the environmental protective covering of plants (cuticle) and animals (skin). AGIIS has low volatility at room temperature and pressure. Even as concentrated as 29 N, the AGIIS has no odor, does not give off fumes in the air, and is not irritating to a human nose when one smells this concentrated solution.

Yet another acidulant of the present invention is to a composition of a highly acidic metalated organic acid (“HAMO”). The composition may have a suspension of very fine particles, and it has a monovalent or a polyvalent cation, an organic acid, and an anion of a regenerating acid, such as the anion of a strong oxyacid. The term “highly acidic” means the pH is in the acidic region, below at least about 4, preferably 2.5. HAMO of the present invention is less corrosive to a ferrous metal than a solution of a mineral acid having the same acidic pH value as that of the acidic composition. HAMO is also more biocidal than a mixture of the organic acid and a metal salt of the organic acid which mixture having the same acid normality value as that of the acidic composition.

Broadly, one way HAMO can be prepared is by mixing the following ingredients: (1) at least one regenerating acid; (2) at least one metal base; and (3) at least one organic acid, wherein the equivalent amount of the regenerating acid is in excess of the equivalent amount of the metal base. The equivalent amount of the metal base should be about equal to that of the organic acid. Instead of using a metal base and an organic acid, a metal salt of the organic acid can be used in place of the metal base and the organic acid. The insoluble solid is removed by any conventional method, such as sedimentation, filtration, or centrifugation.

Generally, HAMO can be prepared by blending or mixing the necessary ingredients in at least the following manners:

1. Regenerating acid+(metal base+organic acid);

2. Regenerating acid+(metal base+salt of organic acid);

3. (Regenerating acid+salt of organic acid)+base; and

4. Regenerating acid+salt of organic acid.

The parenthesis in the above scheme denotes “pre-mixing” the two ingredients recited in the parenthesis. Normally, the regenerating acid is added last to generate the HAMO. Although each of the reagents is listed as a single reagent, optionally, more than one single reagent, such as more than one regenerating acid or organic acid, can be used in the current invention. The number of equivalents of the regenerating acid must be larger than the number of equivalents of the metal base, or those of the metal salt of the organic acid. When the organic acid is an amino acid, which, by definition contains at least one amino group, then the number of equivalents of the regenerating acid must be larger than the total number of equivalents of the metal base, or metal salt of the organic acid, and the “base” amino group of the amino acid. Thus, the resultant highly acidic metalated organic acid is different from, and not, a buffer. See, “Highly Acidic Metalated Inorganic Acid,” U.S. application Ser. No. 09/655,131, filed Sep. 5, 2000, the entire content of which is hereby incorporated by reference.

As used herein, a regenerating acid is an acid that will “re-generate” the organic acid from its salt. Examples of a regenerating acid include a strong binary acid, a strong oxyacid, and others. A binary acid is an acid in which protons are directly bound to a central atom, that is (central atom)-H. Examples of a binary acid include HF, HCl, HBr, HI, H₂S and HN₃. An oxyacid is an acid in which the acidic protons are bound to oxygen, which in turn is bound to a central atom, that is (central atom)—O—H. Examples of oxyacid include acids having Cl, Br, Cr, As, Ge, Te, P, B, As, I, S, Se, Sn, Te, N, Mo, W, or Mn as the central atom. Some examples include H₂SO₄, HNO₃, H₂SeO₄, HClO₄, H₃PO₄, and HMnO₄. Some of the acids (e.g. HMnO₄) cannot actually be isolated as such, but occur only in the form of their dilute solutions, anions, and salts. A “strong oxyacid” is an oxyacid, which at a concentration of 1 molar in water gives a concentration of H₃O⁺ greater than about 0.8 molar.

The regenerating acid can also be an acidic solution of sparingly-soluble Group IIA complexes (“AGIIS”).

That “adduct” is a mixture of an acidulant and an “additive.” The “additive” of the present invention appears to enhance, and also appears to be synergistic to, the effectiveness of the acidic composition of the present invention. Examples of the additive include alcohol, organic acid, periodic acid, and surfactant. The amount of additive added to the AGIIS varies depending on the desired final weight percent of the additive in the final adduct composition. The weight percent of additive needed for the adduct composition of the present invention can vary from about 0.01 to about 99.99, based on the total weight of the final adduct composition. The alcohol additive preferred for the present invention includes methanol, ethanol, 1-propanol, 2-propanol, and other lower alkyl alcohols.

Organic acid additive of the present invention includes carboxylic acid. A carboxylic acid is an organic compound containing the —COOH group, i.e., a carbonyl attached to a hydroxyl group. Preferred organic acids for the present invention include lactic acid, acetic acid, propionic acid, oxalic acid, sorbic acid, butyric acid, benzoic acid, glycolic acid, peracetic acid, and a mixture thereof.

A surfactant additive for the present invention is a surface-active agent. It is usually an organic compound consisting of two parts: One, a hydrophobic portion, usually including a long hydrocarbon chain; and two, a hydrophilic portion which renders the compound sufficiently soluble or dispersible in water or another polar solvent. Surfactants are usually classified into: (1) anionic, where the hydrophilic moiety of the molecule carries a negative charge; (2) cationic, where this moiety of the molecule carries a positive charge; and (3) non-ionic, which do not dissociate, but commonly derive their hydrophilic moiety from polyhydroxy or polyethoxy structures. Other surfactants include ampholytic and zwitterionic surfactants. A preferred surfactant for the present invention includes polysorbates (Tween 80). See, “Adduct Having an Acidic Solution of Sparingly-Soluble Group IIA Complexes,” U.S. application Ser. No. 09/09/500,474, filed Feb. 09, 2000, the entire content of which is hereby incorporated by reference.

Unless otherwise defined, the amount of each ingredient or component of the present invention is based on the weight percent of the final composition, usually the concentrate before further dilution to achieve the desired pH of about 1.8. The AGIIS having a pH of about 1.8 is usually further diluted with water before applying to an animal product or a plant product.

As used herein, the term “nutriment” means something that nourishes, heals, or promotes growth and repairs the natural wastage of organic life. Thus, food for a human or an animal, are all examples of nutriment. Sometimes, food for an animal is termed “feed.” Other examples of nutriment include beverages, food additive, beverage additive, food supplement, beverage supplement, seasoning, spices, flavoring agent, stuffing, sauce, food dressing, diary products, pharmaceutical, biological product, and others. The nutriment can be of plant origin, animal origin, or synthetic.

As used herein, the term “acidulant” means: (a) An acidic, or low pH, solution of sparingly-soluble Group IIA complexes (“AGIIS”); (b) a highly acidic metalated mixture of inorganic acid (“HAMMIA”); (c) a highly acidic metalated organic acid (“HAMO”); (d) a mixture of the above; or (e) an adduct of each of the above. The term “adduct” means a mixture of an “additive” and an acidic composition, or mixture thereof, of the above.

As used herein, the term “pathogen” means any microorganism, bacteria, virus, or other substance that can cause disease in an animal.

As used herein, the term “contacting” means spraying on, immersed in, adhered to, absorbed to, blended in, mixed in, or incorporated in.

The following examples are provided to further illustrate this invention and the manner in which it may be carried out. It will be understood, however, that the specific details given in the examples have been chosen for purposes of illustration only and not be construed as limiting the invention. Unless otherwise defined, the amount of each ingredient or component of the present invention is based on the weight percent of the final composition.

### EXAMPLE 1

### AGIIS Having an Acid Normality of 1.2 To 1.5 Prepared by the Method of H₂SO₄/Ca(OH)₂

An amount of 1055 ml (19.2 moles, after purity adjustment and taking into account the amount of acid neutralized by base) of concentrated sulfuric acid (FCC Grade, 95-98% purity) was slowly added with stirring, to 16.868 L of RO/DI water in each of reaction flasks a, b, c, e, and f. The amount of water had been adjusted to allow for the volume of acid and the calcium hydroxide slurry. The mixture in each flask was mixed thoroughly. Each of the reaction flasks was chilled in an ice bath and the temperature of the mixture in the reaction flask was about 8-12° C. The mixture was continuously stirred at a rate of about 700 rpm.

Separately, a slurry was made by adding RO/DI water to 4 kg of calcium hydroxide (FCC Grace, 98% purity) making a final volume of 8 L. The mole ratio of calcium hydroxide to concentrated sulfuric acid was determined to be 0.45 to 1. The slurry was a 50% (w/v) mixture of calcium hydroxide in water. The slurry was mixed well with a high-shear-force mixer until the slurry appeared uniform. The slurry was then chilled to about 8-12° C. in an ice bath and continuous stirred at about 700 rpm.

To each of the reaction flasks was added 150 ml of the calcium hydroxide slurry every 20 minutes until 1.276 L (i.e. 638 g dry weight, 8.61 moles, of calcium hydroxide) of the slurry had been added to each reaction vessel. The addition was again accompanied by efficient mixing at about 700 rpm.

After the completion of the addition of the calcium hydroxide to the reaction mixture in each reaction vessel, the mixture was filtered through a 5-micron filter.

The filtrate was allowed to sit for 12 hours, the clear solution was decanted to discard any precipitate formed. The resulting product was AGIIS having an acid normality of 1.2-1.5.

### EXAMPLE 2

### AGIIS Having an Acid Normality of 2 Prepared by the Method of H₂SO₄/Ca(OH)₂/CaSO₄

For the preparation of 1 L of 2 N AGIIS, an amount of 79.5 ml (1.44 moles, after purity adjustment and taking into account the amount of acid to be neutralized by base) of concentrated sulfuric acid (FCC Grade, 95-98% purity) was slowly added, with stirring, to 854 ml of RO/DI water in a 2 L reaction flask. Five grams of calcium sulfate (FCC Grade, 95% purity) was then added slowly and with stirring to the reaction flask. The mixture was mixed thoroughly. At this point, analysis of the mixture would usually indicate an acid normality of 2.88. The reaction flask was chilled in an ice bath and the temperature of the mixture in the reaction flask was about 8-12° C. The mixture was continuously stirred at a rate of about 700 rpm.

Separately, a slurry was made by adding 50 ml of RO/DI water to 33.26 g (0.44 mole, after purity adjustment) of calcium hydroxide (FCC Grace, 98% purity) making a final volume of 66.53 ml. The mole ratio of calcium hydroxide to concentrated sulfuric acid was determined to be 0.44 to 1. The slurry was mixed well with a high-shear-force mixer until the slurry appeared uniform. The slurry was then chilled to about 8-12° C. in an ice bath and continuous stirred at about 700 rpm.

The slurry was then slowly added over a period of 2-3 hours to the mixture, still chilled in an ice bath and being stirred at about 700 rpm.

After the completion of the addition of slurry to the mixture, the product was filtered through a 5-micron filter. It was normal to observe a 20% loss in volume of the mixture due to the retention of the solution by the salt and removal of the salt.

The filtrate was allowed to sit for 12 hours, and the clear solution was then decanted to discard any precipitate formed. The resulting product was AGIIS having an acid normality of 2.

### EXAMPLE 3

### AGIIS Having an Acid Normality of 12 Prepared by the Method of H₂SO_{4/}Ca(OH)₂/CaSO₄

For the preparation of 1 L of 12 N AGIIS, an amount of 434 ml (7.86 moles, after purity adjustment and taking into account amount of acid neutralized by base) of concentrated sulfuric acid (FCC Grade, 95-98% purity) was slowly added, with stirring, to 284.60 ml of RO/DI water in a 2 L reaction flask. Three grams of calcium sulfate (FCC Grade, 95% purity) was then added slowly and with stirring to the reaction flask. The mixture was mixed thoroughly. The reaction flask was chilled in an ice bath and the temperature of the mixture in the reaction flask was about 8-12° C. The mixture was continuously stirred at a rate of about 700 rpm.

Separately, a slurry was made by adding 211 ml of RO/DI water to 140.61 g (1.86 moles, after purity adjustment) of calcium hydroxide (FCC Grace, 98% purity) making a final volume of 281.23 ml. The mole ratio of calcium hydroxide to concentrated sulfuric acid was determined to be 0.31. The slurry was mixed well with a high-shear-force mixer until the slurry appeared uniform. The slurry was then chilled to about 8-12° C. in an ice bath and continuous stirred at about 700 rpm.

The slurry was then slowly added over a period of 2-3 hours to the acid mixture, still chilled in an ice bath and being stirred at about 700 rpm.

After the completion of the addition of slurry to the mixture, the product was filtered through a 5-micron filter. It was normal to observe a 20% loss in volume of the mixture due to the retention of the solution by the salt and removal of the salt.

The filtrate was allowed to sit for 12 hours, and the clear solution was then decanted to discard any precipitate formed. The resulting product was AGIIS having an acid normality of 12.

### EXAMPLE 4

### General Procedure 1

Formation of a Phosphoric Acid HAMMIA Using Pre-Formed AGIIS

The phosphate salt of a divalent metal chosen from List A below (1.00 mole equivalents) is suspended in sufficient deionized water to make a final volume of 625 mL per mole of phosphate ions. The mixture may be sonicated or heated as necessary to aid solubilization of the sparingly soluble phosphate salt. To this stirred suspension, a solution of AGIIS containing the desired concentration of acid (3.05 moles of hydrogen ion per mole of phosphate ion; 2.05 moles of hydrogen ion per mole of hydrogen phosphate ion; 1.05 moles of hydrogen ion per mole of dihydrogen phosphate ion) is added in 10-mL aliquots with the pH being monitored after each addition. Copious precipitates of calcium sulfate form beginning at pH 2. The addition of AGIIS solution may be discontinued as soon as the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A: Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

### EXAMPLE 5

### General Procedure 2

Formation of a Phosphoric Acid HAMMIA Using AGIIS Formed in Situ

A mixture of calcium hydroxide (1.00 mole equivalents) and the phosphate salt of a divalent metal chosen from List A below (1.00 mole equivalents) is suspended in sufficient deionized water to make a final volume of approximately 400 mL per mole of metal ions. The mixture may be sonicated or heated as necessary to aid solubilization of the sparingly soluble metal salts. To this stirred suspension, concentrated sulfuric acid (5.05 mole equivalents of hydrogen ion per mole of phosphate ion) is added in 10-mL aliquots with the pH being monitored after each addition. The addition of acid may be discontinued when the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A: Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

### EXAMPLE 6

### General Procedure 3

Formation of a Phosphoric Acid HAMMIA Containing a Monovalent Metal Using Pre-formed AGIIS

The phosphate salt of a divalent metal chosen from List A below (1.00 mole equivalents) and the phosphate salt of a monovalent metal chosen from List B below (≦1.00 mole equivalents) is suspended in sufficient deionized water to make a final volume of 625 mL per mole of phosphate ions. The mixture may be sonicated or heated as necessary to aid solubilization of the sparingly soluble divalent metal phosphate salt. To this stirred suspension, a solution of AGIIS containing the desired concentration of acid (3.05 moles of hydrogen ion per mole of phosphate ion; 2.05 moles of hydrogen ion per mole of hydrogen phosphate ion; 1.05 moles of hydrogen ion per mole of dihydrogen phosphate ion) is added in 10-mL aliquots with the pH being monitored after each addition. Copious precipitates of calcium sulfate form beginning at pH 2. The addition of AGIIS solution may be discontinued as soon as the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A:

Divalent Metal Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

List B:

Monovalent Metal Phosphate Salts

Li₃PO₄, Li₂HPO₄, LiH₂PO₄

Na₃PO₄, Na₂HPO₄, NaH₂PO₄

K₃PO₄, K₂HPO₄, KH₂PO₄

### EXAMPLE 7

### General Procedure 4

### Formation of a Phosphoric Acid HAMMIA Containing a Monovalent Metal Using AGIIS Formed in Situ

A mixture of calcium hydroxide (1.00 mole equivalents) and the phosphate salt of a divalent metal chosen from List A below (1.00 mole equivalents) is suspended in sufficient deionized water to make a final volume of approximately 400 mL per mole of metal ions. The phosphate salt of a monovalent metal chosen from List B below (≦1.00 mole equivalents) is added to the mixture. The mixture may be sonicated or heated as necessary to aid solubilization of the sparingly soluble divalent metal salts. To this stirred suspension, concentrated sulfuric acid (5.05 mole equivalents of hydrogen ion per mole of phosphate ion) is added in 10-mL aliquots with the pH being monitored after each addition. The addition of acid may be discontinued when the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A:

Divalent Metal Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

List B:

Monovalent Metal Phosphate Salts

Li₃PO₄, Li₂HPO₄, LiH₂PO₄

Na₃PO₄, Na₂HPO₄, NaH₂PO₄

K₃PO₄, K₂HPO₄, KH₂PO₄

### EXAMPLE 8

### General Procedure 5

Formation of a Phosphoric Acid HAMMIA Containing a Monovalent Metal and an Additive Acid Using Pre-formed AGIIS

One or more of the acids from List C below (up to 6 mole equivalents), the phosphate salt of a divalent metal chosen from List A below (1.00 mole equivalents) and the phosphate salt of a monovalent metal chosen from List B below (≦1.00 mole equivalents) are suspended in sufficient deionized water to make a final volume of 625 mL per mole of phosphate ions. The mixture may be sonicated or heated as necessary to aid solubilization of the sparingly soluble divalent metal phosphate salt. To this stirred suspension, a solution of AGIIS containing the desired concentration of acid (3.05 moles of hydrogen ion per mole of phosphate ion; 2.05 moles of hydrogen ion per mole of hydrogen phosphate ion; 1.05 moles of hydrogen ion per mole of dihydrogen phosphate ion) is added in 10-mL aliquots with the pH being monitored after each addition. Copious precipitates of calcium sulfate form beginning at pH 2. The addition of AGIIS solution may be discontinued as soon as the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A

Divalent Metal Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

List B:

Monovalent Metal Phosphate Salts

Li₃PO₄, Li₂HPO₄, LiH₂PO₄

Na₃PO₄, Na₂HPO₄, NaH₂PO₄

K₃PO₄, K₂HPO₄, KH₂PO₄

List C:

Additive Acids

formic acid, acetic acid, propionic

acid, butyric acid, malic acid,

glycolic acid, maleic acid, gluconic

acid, periodic acid, peracetic acid,

monoperphthalic acid, benzoic acid,

sorbic acid, oxalic acid.

### EXAMPLE 9

### General Procedure 6

### Formation of a Phosphoric Acid HAMMIA Containing a Monovalent Metal and an Additive Acid Using AGIIS Formed in Situ

A mixture of calcium hydroxide (1.00 mole equivalents) and the phosphate salt of a divalent metal chosen from List A below (1.00 mole equivalents) is suspended in sufficient deionized water to make a final volume of approximately 400 mL per mole of metal ions. One or more of the acids from List C below (up to 6 mole equivalents), and phosphate salt of a monovalent metal chosen from List B below (≦1.00 mole equivalents) is added to the mixture. The mixture may be sonicated or heated as necessary to aid solubilization of the sparingly soluble divalent metal salts. To this stirred suspension, concentrated sulfuric acid (5.05 mole equivalents of hydrogen ion per mole of phosphate ion) is added in 10-mL aliquots with the pH being monitored after each addition. The addition of acid may be discontinued when the desired pH is reached. After the addition of the acid is complete, the mixture is stirred for one hour. The agitation is then stopped and the mixture is allowed to settle overnight (approximately 18 hours). The suspended solids are removed by centrifugation at 16000 rpm for 30 minutes. The supernatant solution is the HAMMIA.

List A:

Divalent Metal Phosphate Salts

Mg₃(PO₄)₂, MgHPO₄, Mg(H₂PO₄)₂

Ca₃(PO₄)₂, CaHPO₄, Ca(H₂PO₄)₂

Mn₃(PO₄)₂, MnHPO₄, Mn(H₂PO₄)₂

Fe₃(PO₄)₂, FeHPO₄, Fe(H₂PO₄)₂

Co₃(PO₄)₂, CoHPO₄, Co(H₂PO₄)₂

Ni₃(PO₄)₂, NiHPO₄, Ni(H₂PO₄)₂

Cu₃(PO₄)₂, CuHPO₄, Cu(H₂PO₄)₂

Zn₃(PO₄)₂, ZnHPO₄, Zn(H₂PO₄)₂

List B:

Monovalent Metal Phosphate Salts

Li₃PO₄, Li₂HPO₄, LiH₂PO₄

Na₃PO₄, Na₂HPO₄, NaH₂PO₄

K₃PO₄, K₂HPO₄, KH₂PO₄

List C:

Additive Acids

formic acid, acetic acid, propionic

acid, butyric acid, malic acid,

glycolic acid, maleic acid, gluconic

acid, periodic acid, peracetic acid,

monoperphthalic acid, benzoic acid,

sorbic acid, oxalic acid.

### EXAMPLE 10

### Preparation of HAMMIA and Adduct Containing HAMMIA and Additive

Procedure A

The phosphate salt of a divalent metal chosen from List C below (1.00 mole equivalents) is suspended in sufficient deionized water to make a final volume of 625 mL per mole of phosphate ions. The mixture may be sonicated 30 minutes or heated as necessary to aid solubilization of the sparingly soluble phosphate salt. To this stirred suspension concentrated sulfuric acid (167.5 mL per mole of phosphate ions, 97%, 3.05 mole equivalents) is added in 10-mL aliquots each 20 minutes. Below pH 2, copious precipitation of calcium sulfate begins. After the addition of the acid is complete, the mixture is stirred for one hour and the agitation is stopped and the mixture is allowed to settle overnight (approximately 18 hours). The suspended solids are removed by centrifugation at 16000 rpm for 30 minutes.

The supernatant resulting from this procedure using calcium phosphate, Ca₃(PO₄)₂, had a volume of approximately 1 L, a pH of approximately 0.0-0.5, and contained approximately 1000 ppm Ca, 3.80×10⁵ ppm SO₄, and 1.14×10⁵ ppm PO₄.

List C: Phosphate Salts

Mg₃(PO₄)₂

Ca₃(PO₄)₂

Mn₃(PO₄)₂

Fe₃(PO₄)₂

Co₃(PO₄)₂

Ni₃(PO₄)₂

Cu₃(PO₄)₂

Zn₃(PO₄)₂

Procedure B

The monohydrogen phosphate salt of a divalent metal chosen from List D below (7.35 moles) is placed in an 8-L container and to deionized water (1.0 L) is added. The mixture is stirred using high shear force mixing during all subsequent additions. To this stirred suspension 1.45 L of a solution of AGIIS having an acid normality of 5.2 N is added in 10-mL aliquots, below pH 2, copious precipitation of calcium sulfate begins. After addition of 1.45 L of sulfuric acid, the pH of the mixture is approximately 1.0. After the addition of the acid is complete, a 2-L sample of the mixture is centrifuged at 15000 rpm for 20 minutes.

The supernatant resulting from this procedure using calcium monohydrogen phosphate (CaHPO₄) had a pH of approximately 1.23, and contained approximately 88 ppm Ca, 1800 ppm SO₄, and 1.48×10⁵ ppm PO₄.

List D: Monohydrogen Phosphate Salts

MgHPO₄

CaHPO₄

MnHPO₄

FeHPO₄

CoHPO₄

NiHPO₄

CuHPO₄

ZnHPO₄

Procedure C

The monohydrogen phosphate salt of a divalent metal chosen from List D above (11.0 moles) is placed in an 8-L container and deionized water (2.0 L) is added. The mixture is stirred using high shear force mixing during all subsequent additions. To this stirred suspension concentrated sulfuric acid (up to 500 mL, up to 9.15 moles) is added in 10-mL aliquots. The pH may be monitored, and the addition of sulfuric acid ceased when the desired pH is reached. The pH of the solution varies with the quantity of sulfuric acid added approximately as follows: pH 3.0, 40 mL; pH 2.0, 90 mL; pH 1.0, 240 mL; pH 0.5, 380 mL; pH 0.0 450 mL; pH<0, 470 mL. Below pH 2, copious precipitation of calcium sulfate occurs. After the addition of the sulfuric acid is complete, the mixture is centrifuged at 15000 rpm for 15-20 minutes.

The supernatant resulting from this procedure using calcium monohydrogen phosphate (CaHPO₄) and 500 mL of concentrated sulfuric acid had an acid concentration of approximately 7 N, and contained approximately 1.38×10⁴ ppm SO₄, 4.44×10⁵ ppm PO₄, 1.1×10³ ppm Ca.

Procedure D

Concentrated phosphoric acid (1L, 16.8 moles) is placed in a container. The oxide, hydroxide, carbonate or basic carbonate salt of a divalent metal chosen from List E below (17.1 moles) is added in 50-g portions to the phosphoric acid and the mixture is well mixed after each addition. Water (2.9 L) is added as necessary to permit efficient mixing of the mixture. After the addition of the base and the water is complete, concentrated sulfuric acid (927 mL, 17.0 moles) is added to the stirred solution in 1 0-mL aliquots at a rate of 10 mL per 15 minutes. The pH of the solution varies with the quantity of sulfuric acid added approximately as follows: pH 3.0, 30 mL; pH 2.0, 120 mL; pH 1.0, 480 mL; pH 0.5, 640 mL; pH 0.0 710 mL; pH<0, 760 mL. Below pH 2, copious precipitation of calcium sulfate occurs. After the addition of the acid is complete, deionized water (500 mL) is added and the mixture is stirred well. Agitation is then stopped, and the mixture is allowed to settle overnight (approximately 18 hours). The suspended solids are removed by centrifugation at 15000 rpm for 20 minutes.

The supernatant resulting from this procedure using calcium hydroxide (Ca(OH)₂) had a pH below 0.0, and contained approximately 250 ppm Ca, 1.00×10⁵ ppm SO₄, and 3.19×10⁵ ppm PO₄.

List E: Metal bases

MgO, Mg(OH)₂, MgCO₃, xMgO·yMgCO₃

CaO, Ca(OH)₂, CaCO₃

MnO, Mn(OH)₂, MnCO₃, xMnO·yMnCO₃

FeO, Fe(OH)₂, FeCO₃, xFeO·yFeCO₃

CoO, Co(OH)₂, CoCO₃, xCoO·yCoCO₃

NiO, Ni(OH)₂, NiCO₃, xNiO·yNiCO₃

CuO, Cu(OH)₂, CuCO₃, xCuO·yCuCO₃

ZnO, Zn(OH)₂, ZnCO₃, xZnO·yZnCO₃

Procedure D-1

Propionic acid (110 mL, 1.48 mol) was dissolved in deionized water (890 mL) and a solution of AGIIS (5 N, 74 mL, 0.37 mol hydrogen ion) was added. This solution was stirred, and then solid calcium dihydrogen phosphate (25 g, 0.0214 moles) and calcium hydrogen phosphate (5 g, 0.184 moles) were added with vigorous stirring. As necessary, the mixture was centrifuged to remove suspended solids. The solution prepared by this method had a pH of approximately 1.5, and contained 2.6×10⁴ ppm PO₄, 3.1×10³ ppm SO₄, and 9.3×10⁴ ppm C₂H₅CO₂H.

The same solution may be prepared as a five-fold concentrate by following the same procedure as modified below. The initial solution is prepared by mixing 550 mL (7.37 moles) of propionic acid and 450 mL of water. To this solution, AGIIS (5 N, 370 mL, 1.85 moles hydrogen ion) is added. This solution is stirred, and calcium dihydrogen phosphate (25 g, 0.107 moles) and calcium monohydrogen phosphate (125 g, 0.92 moles) are added portionwise with vigorous mixing. As necessary, suspended solids are removed from the final mixture by centrifugation. The resultant solution contains approximately 4.73×10⁴ ppm PO₄, 2.15×10⁵ ppm SO₄, and 4.11×10⁵ ppm C₂H₅CO₂H. Dilution of this solution (200 mL) with deionized water (800 mL) gives a solution with a pH of approximately 1.1, and containing approximately 9.0×10³ PO₄, 6.4×10³ ppm SO₄, and 7.6×10⁴ ppm C₂H₅CO₂H.

Procedure D-2

Propionic acid (110 mL, 1.48 mol) was dissolved in deionized water (890 mL) and a solution of AGIIS (5 N, 40 mL, 0.25 mol hydrogen ion) was added in 10-mL aliquots. This solution was stirred, and then solid sodium hydrogen phosphate (Na₂HPO₄, 22 g, 0.155 moles) was added portionwise (4×5 g, 1×2 g) with vigorous stirring. After the addition of sodium hydrogen phosphate, an additional 45 mL of water was added to bring the total volume to 1.0 L. The solution prepared by this method had a pH of approximately 1.5, and contained 7.9×10³ ppm PO₄, 1.1×10⁴ ppm SO₄, and 1.0×10⁵ ppm C₂H₅CO₂H.

The same solution may be prepared as a six-fold concentrate by following the same procedure as modified below. The initial solution is prepared by mixing 660 mL (8.84 moles) of propionic acid and 170 mL of water. To this solution, AGIIS (5 N, 240 mL, 1.2 moles hydrogen ion) is added. This solution is stirred, and sodium monohydrogen phosphate (Na₂HPO₄, 132 g, 0.93 moles) is added portionwise with vigorous mixing.

Procedure D-3

Propionic acid (110 mL, 1.48 mol) and lactic acid (100 mL, 85% in water, 103 g, 1.14 mol) were dissolved in deionized water (650 mL) and a solution of AGIIS (5 N, 28 mL, 0.14 mol hydrogen ion) was added in 10-mL aliquots. This solution is stirred, and then solid sodium hydrogen phosphate (71 g, 0.119 moles) was added portionwise with vigorous stirring. Water (90 mL) was added after addition of the sodium phosphate salts was complete. The solution prepared by this method contained approximately 6.5×10³ ppm PO₄, 7.2×10³ ppm SO₄, 1.0×10⁵ ppm C₂H₅CO₂H and 9.0×10⁴ ppm CH₃CH(OH)CO₂H.

The same solution may be prepared as a three-fold concentrate by following the same procedure as modified below. The initial solution is prepared by mixing 330 mL (4.03 moles) of propionic acid, 330 mL (308 g, 3.76 moles) of lactic acid, and 240 mL of water. A solution of AGIIS (5 N, 84 mL, 0.425 moles hydrogen ion) is added to the stirred solution. Solid sodium monohydrogen phosphate (52 g, 0.37 moles) is added portionwise with vigorous mixing. The resultant solution contains approximately 1.8×10⁴ ppm PO₄, 2.2×10⁴ ppm SO₄, and 3.6×10⁵ ppm C₂H₅CO₂H and 3.3×10⁵ ppm CH₃CH(OH)CO₂H. Dilution of this solution 1:3 with deionized water gives a solution containing approximately 5.8×10³ ppm PO₄, 7.0×10³ ppm SO₄, 1.0×10⁵ ppm C₂H₅CO₂H and 9.6×10⁴ ppm CH₃CH(OH)CO₂H.

The same three-fold concentrate may be prepared in gallon quantities by following the procedure as modified below. The initial solution is prepared by mixing 1250 mL of propionic acid, 1250 mL of 85% lactic acid, and 908 mL of water. A solution of AGIIS (5 N, 318 mL) is added to the stirred solution. Solid sodium monohydrogen phosphate (193 g) is added portionwise with vigorous mixing. Dilution of this solution 1:3 with deionized water gives a solution with a pH of 1.5, and containing approximately 1.9×10³ ppm PO₄, 3.3×10³ ppm SO₄, 1.0×10⁵ ppm C₂H₅CO₂H and 11×10⁵ ppm CH₃CH(OH)CO₂H.

Procedure D-4

Calcium phosphate (500 g, 1.61 moles) was added to an 8-L container and a solution of AGIIS (1.0 L, 5 N, 5.0 moles hydrogen ion) was added dropwise at a rate of approximately 2 mL/minute. The mixture was stirred well, and deionized water (500 mL) was added to aid stirring. A further 500 mL of the AGIIS solution (5 N, 2.5 moles hydrogen ion) was added dropwise at a rate of approximately 2 mL/minute with vigorous stirring. The solids were removed from the resultant mixture by centrifugation at 15000 rpm for 20 minutes. The supernatant solution was used as the HAMMIA.

The HAMMIA prepared by this method had a pH of 1.0-1.5, and contained approximately 1.2×10⁴ ppm Ca²⁺, 1.6×10³ ppm SO₄, and 1.5×10⁵ ppm PO₄.

### Discussion

Although not wanting to be bound by any theory, the various adducts solutions containing HAMMIA and an additive acid as well as the various HAMMIA solutions were formed by the regeneration of phosphoric acid from its salts by a regenerating acid. The formation of the acidic solutions led to solutions that, when brought to a pH below 1.0, no longer had a substantial concentration of the metal ion (with calcium salts, the calcium ion concentration was around or below 1000 ppm, i.e. around or below 0.025 M). In most of the solutions prepared with calcium salts, the calcium ion concentration was below 200 ppm (0.005 M), when the pH was below 1. Thus, these with solutions pH<1 cannot, in general, be equated with a traditional buffer solution, where the concentrations of the metal salt are typically in the 0.1-0.5 M range. However, the anion concentrations are in the much higher concentration ranges; the simplest interpretation of the data would suggest that the solutions contain hydronium ion as the most prevalent cation present. Such solutions might meet the pro forma definition of a buffer, but such solutions will not behave as a functional buffer solution. It is noteworthy that the generation of these solutions appeared to pass through a buffer solution phase, where the addition of substantial volumes of the strong regenerating acid (usually AGIIS) had little effect on the pH of the mixture, but after the addition of the theoretical amount of regenerating acid, the pH dropped rapidly with additional regenerating acid. In the pH range above 1, and more especially above 1.5, the solution might act as a calcium dihydrogen phosphate buffer, and, as such, the calcium ion concentration may be much higher than in the pH<1 solutions. Indeed, until the rapid drop of pH with added regenerating acid, it is possible to have quite high calcium ion concentrations of several thousand parts per million (as high as 0.3 M).

### EXAMPLE 11

### Another Formation of HAMO from Glycolic Acid

1 kg of glycolic acid was dissolved into 1.5 L water. 482 g of calcium hydroxide was slowly added to the solution at which time the entire slurry solidified. 2.75 L of 4.8 N AGIIS was added in 50-ml intervals. The final volume was 5.0 L. The final pH was 1.0-1.5.

### EXAMPLE 12

### General Method for the Formation of an Amino Acid HAMO Using 1.2 M Sulfuric Acid as Regenerating Acid

A solution of dilute sulfuric acid approximately 1.2 M in sulfuric acid was prepared by weighing 111.64 g of concentrated (96-98%) sulfuric acid and diluting with water to 1000 mL.

The amino acid or its hydrochloride salt (0.025-0.1 mole) was weighed into an Erlenmeyer flask and approximately 10 mole equivalents of water was added. Solid calcium hydroxide (7.40 g, 0.10 mol) was added to the flask and the mixture was stirred at room temperature for 30 minutes to ensure complete reaction. The dilute sulfuric acid (84.0 mL, 0.10 moles H₂SO₄) was then added to the mixture. The mixture was filtered through a medium-porosity glass frit to give the HAMO. The total acid content of the HAMO was determined by titration against standard tris-(hydroxymethyl)aminomethane (“THAM”).

HAMOs Prepared From Amino Acids by This Method

| Amino Acid | Moles of Amino Acid | H₃O+] in HAMO* | |
|---|---|---|---|
| L-glutamine | 0.10 | 0.133 | M¹ |
| L-phenylalanine | 0.05 | 0.185 | M² |
| L-asparagine | 0.10 | 0.070 | M³ |
| L-histidine.HCl | 0.10 | 0.57 | M |
| L-glutamic acid | 0.10 | 0.124 | M⁴ |
| L-aspartic acid | 0.10 | 0.170 | M⁵ |
| L-lysine.HCl | 0.10 | 0.56 | M⁶ |
| L-leucine | 0.10 | 0.173 | M⁷ |
| L-alanine | 0.10 | 0.099 | M⁸ |
| L-isoleucine | 0.02 | 0.351 | M⁹ |
| L-serine | 0.025 | 0.274 | M |

*Molarity
¹Ca, 844 ppm; SO₄, 3,120 ppm
²Ca, 390 ppm; SO₄, 13,900 ppm.
³Ca, 625 ppm; SO₄, 3,120 ppm.
⁴Ca, 646 ppm; SO₄, 5,120 ppm.
⁵Ca, 1,290 ppm; SO₄, 3,850 ppm.
⁶Ca, 1,910 ppm; SO₄, 7,560 ppm.
⁷Ca, 329 ppm; SO₄, 315,000 ppm.
⁸Ca, 1,230 ppm; SO₄, 4,480 ppm.
⁹Ca, 749 ppm; SO₄, 314,000 ppm.

HAMOs Prepared With Amino Acids and Metal Bases*

| Amino Acid | Metal Base | Regenerating Acid |
|---|---|---|
| L-glutamine | Ca(OH)2 | H₂SO₄ |
| L-phenylalanine | Ca(OH)₂ | H₂SO₄ |
| L-asparagine | Ca(OH)₂ | H₂SO₄ |
| L-histidine.HCl | Ca(OH)₂ | H₂SO₄ |
| L-glutamic acid | Ca(OH)₂ | H₂SO₄ |
| L-aspartic acid | Ca(OH)₂ | H₂SO₄ |
| L-lysine.HCl | Ca(OH)₂ | H₂SO₄ |
| L-leucine | Ca(OH)₂ | H₂SO₄ |
| L-alanine | Ca(OH)₂ | H₂SO₄ |
| L-isoleucine | Ca(OH)₂ | H₂SO₄ |
| L-serine | Ca(OH)₂ | H₂SO₄ |
| glycine | Ca(OH)₂ | H₂SO₄ |
| L-glutamic acid | CuCO₃.Cu(OH)₂ | H₃PO₄ |
| L-glutamic acid | 2CoCO₃.3Co(OH)₂ | H₃PO₄ |
| L-glutamic acid | MnCO₃ | H₃PO₄ |

*Each of the product has a pH of lower than about 3.

### EXAMPLE 13

Inactivation of E. Coli in Ground Beef by Acidulant

The acidulant used in these experiments was an adduct of AGIIS. The adduct (“ADDT”) was prepared by mixing 22% by volume of AGIIS (prepared from sulfuric acid and calcium hydroxide) and 10% by volume of 85% dl-lactic acid, and water was added to make up the rest of the volume.

ADDT was mixed with a foodstuff contaminated with a food borne pathogen in such a way as to decrease the pathogen's D-values.

E. coli O157:H7 (ground beef isolate) was grown in 10 ml of tryptic soy broth at 37° C. for 18 h with agitation (100 rpm). Bacteria were thrice sedimented by centrifugation at 4,000×g for 20 min and washed in 0.1 M phosphate buffer, pH 7.2. Bacteria were suspended in PBS and adjusted to an OD reading of 0.5 at 630 nm (10⁸ CFU/ml).

Five pounds of ground beef (24% fat) were mixed in a Model H₂ Hobart mixer for 5 min at 176 rpm. 45.4 ml of ADDT was sprayed onto the surface of the meat during mixing. An equal amount of sterile water (45.4 ml) was used as the control group additive. Two batches of 5 pounds each (10 pounds total) were prepared for both AGIIS-treated and untreated ground beef. The ground beef was ground three times through a 15-mm (5/8 in.) plate (Model H₂ Hobart grinder).

Washed cells (1 ml of 10⁸ CFU) of E. coli O157:H7 were inoculated into 100 g of ground beef. Bacteria were mixed into ground beef by massaging with gloved hands for 2 min under a laminar flow hood. A total of 1600 g of inoculated ground beef was prepared of which 800 g was treated with ADDT and 800 g was combined with sterile water (control). After inoculation, ADDT-treated ground beef was divided (ca. about 25 g each) and added to 32 120-ml Whirl Pak bags and the same packaging approach was used for the 800 g of untreated (control) ground beef. Sixteen bags each of the ADDT-treated and control ground beef were held frozen at −20° C. and used within 41 days. Sixteen bags each of ADDT-treated and control ground beef were held refrigerated at 4° C. and used within 10 days.

One-gram portions of refrigerated treated or control ground beef samples were lightly packed under a laminar flow hood into each of 24 Pyrex (10×75 mm) test tubes and capped with rubber stoppers. Frozen ground beef samples were thawed at 21° C. under a laminar hood for 20 to 30 min, then lightly packed in 1-g portions into test tubes as described above. Temperature was monitored by a temperature recorder attached to thermocouples placed in the center of several meat samples. All tubes were submerged in a circulating water bath (VWR Scientific, Model 1265PC) preadjusted to the appropriate temperature (2° C. greater than the desired temperature of the study). Once the meat reached the desired temperature (57, 60, 62.8, 64.3 or 68.3° C.), two tubes were immediately removed and cooled in ice water at about 5° C. The number of E. coli O157 surviving in these samples was the number present at time zero. Duplicate samples were taken at appropriate intervals and enumerated for E. coli O157:H7. Duplicate tests were performed for each temperature treatment. Sampling intervals for ADDT-treated and untreated, unfrozen ground beef were: at 57° C. (0, 5, 10, 15, 20 min); at 60° C. (0, 2, 5, 10, 15 min); 62.8° C. (0, 1, 3, 5, 7, and 9 min); at 64.3° C. (0, 30, 45, 60 and 75 sec); and 68.3° C. (0, 10, 20, 30 and 40 sec). Sampling intervals for ADDT-treated and untreated, frozen ground beef were: at 57° C. (0, 1, 3, 5, 10 and 15 min); at 60° C. (0, 0.5, 1, 2, 5 and 10 min; at 62.8° C. (0, 10, 20, 30, 60, and 90 sec); at 64.3° C. (0, 10, 20, 30, 40 and 60 sec); and at 68.3° C. (0, 10, 20, 30, 40, 50 and 60 sec.

Surviving E. coli O157 were determined by serially diluting (1:10) meat in 0.1% peptone and plating 0.1-ml portions onto duplicate Tryptic soy agar plates. The plates were incubated at 37° C. for 24 h. Colonies on TSA were counted and up to 5 isolates from plates with the highest dilution were confirmed at E. coli O157 by E. coli O157 latex agglutination assay (Oxoid).

Across the tested temperature range, E. coli O157:H7 was consistently more rapidly inactivated in ground beef containing ADDT than in the control ground beef containing no ADDT (Tables 1-4). The D-values of E. coli O157:H7 in the AGIIS-treated beef were approximately 32-75% less than those in the control ground beef (Table 5). Interestingly, the initial counts of E. coli O157:H7 were higher for several heat treatments in the frozen than in the refrigerated ground beef treated with AGIIS. However, the D-values of E. coli O157:H7 were higher in refrigerated than in frozen ground beef irrespective of the addition of ADDT.

The initial E. coli O157:H7 counts in refrigerated ground beef containing ADDT were inexplicably low. However, results indicate the pathogen is inactivated at 62.8° C. more rapidly in ground beef treated with ADDT than in ground beef with no ADDT.

Tables 1-5 demonstrate the effectiveness of the present invention's preferred embodiment. In controlled experiments, the disclosed method of mixing ADDT with ground beef produced a decrease in the resistance to thermal inactivation of E. coli O157:H7 in frozen and refrigerated ground beef that ranged from about 32% to about 75% over the typical cooking temperature range of 57° C. to 68.3° C. (135° F. to 156° F.) as measured by D-value reduction.

The method of the present invention thereby decreases the pathogen's resistance to heat. Consequently, the application of typical cooking temperatures reduces the pathogen's concentration in the foodstuff to levels significantly lower than those achieved by the application of heat to the foodstuff without ADDT.

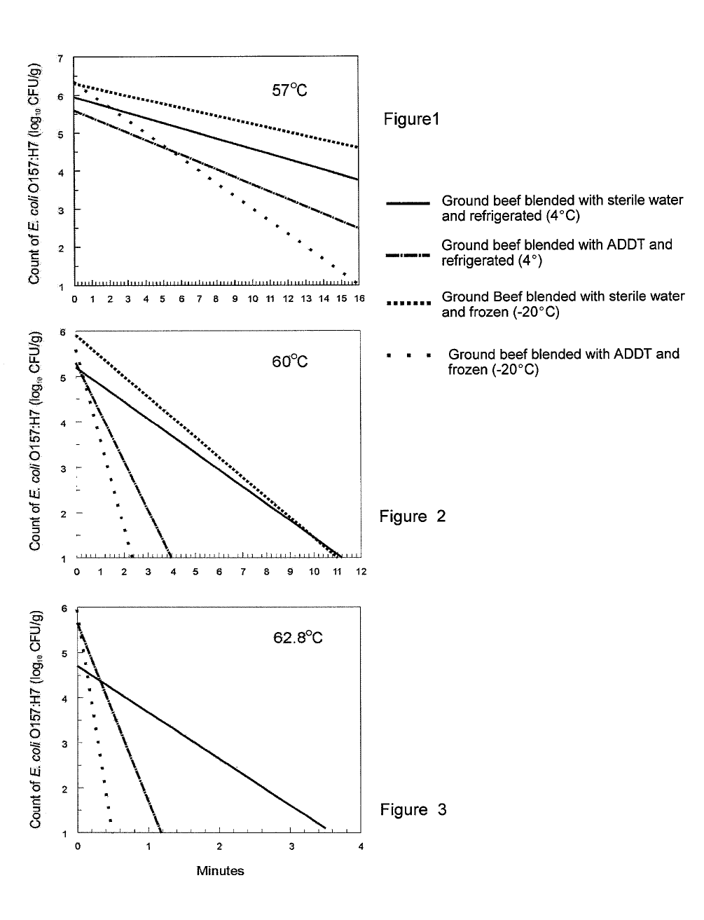

In summary, the addition of ADDT to ground beef substantially increased the rate of thermal inactivation of E. coli O157:H7 in ground beef, with D-values reduced by approximately 1.5- to 4-fold. D-values of E. coli O157:H7 were approximately 2-fold less in frozen than in refrigerated ADDT-treated ground beef, indicating that chilling or freezing further sensitized the pathogen to heat and ADDT treatments. See, FIGS. 1-3, and Table 5.

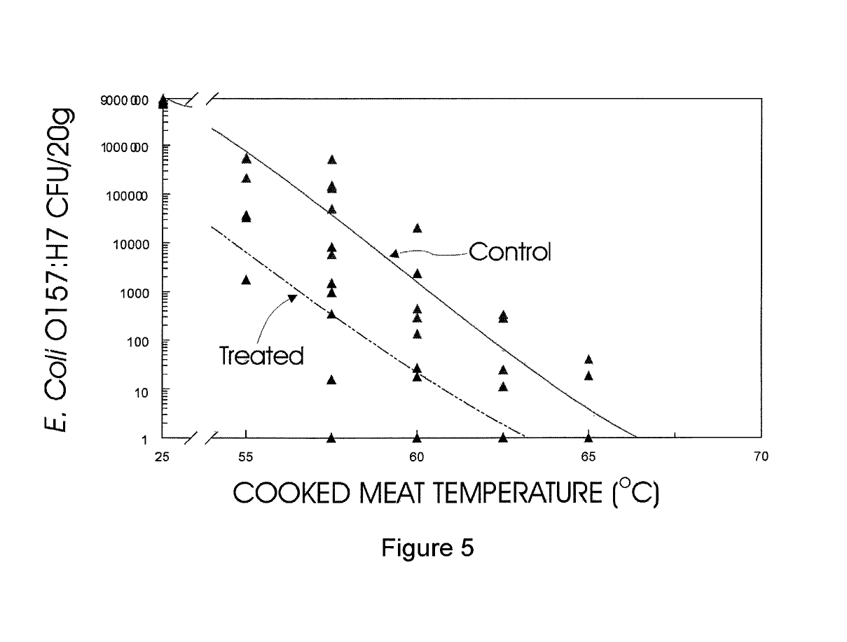

FIG. 5 and FIG. 6 demonstrate the effects of ADDT on the survival of pathogen in ground beef when the meat was cooked at different temperatures.

### Inactivation of Salmonella thyphimurium in Ground Beef by Different Concentrations of Acidulant

The acidulant used in these experiments were Formula A and Formula B, both adducts from AGIIS but having different concentrations. Acidulant Formula A was prepared by mixing 22% by volume of AGIIS (prepared from sulfuric acid and calcium hydroxide) and 10% by volume of 85% dl-lactic acid, and water was added to make up the rest of the volume. Acidulant Formula B was prepared by mixing 10% by volume of AGIIS (prepared from sulfuric acid and calcium hydroxide) and 10% by volume of 85% dl-lactic acid, and water was added to make up the rest of the volume.

Ground beef was ground to 3/32 inch and had a fat content of approximately 20%. Sixty grams of this ground beef was blended with 1.2 ml of the treatment solution. Each of the control and treated meat samples (10 g) was mixed evenly with 0.1 ml of a Salmonella thyphimurium culture such that the final titer was 6.9×10³ CFU/g. The samples were incubated at different times and at different temperatures. Results are shown in Table 6.

Results from these experiments show that acidulant Formula A was 2.2 times stronger than acidulant Formula B. Ground Beef blended with Formula A had a final pH of about 5.2. No discemable differences in taste from the control were noted. The number of decay bacteria detected in samples taken from meat blended with Formula A or formula B, and incubated for 96 hours was significantly reduced compared to the control incubated under similar conditions. The results also demonstrate the bacteria static effects of acidulant Formula A and acidulant Formula B on the potential replication of pathogens and decay bacteria in meat subjected to temperature abuse.

Thus, ground beef blended with the acidulant prevents the replication of decay and pathogenic bacteria in meat stored at temperatures below 11-12° C. These temperatures are the “case-ready” temperatures, namely, the temperatures at which the meat is displayed in a case in a supermarket.

### Inactivation of E. Coli in Ground Beef by Different Concentrations of Acidulant

Acidulant Formula A and acidulant Formula B were prepared as described above.

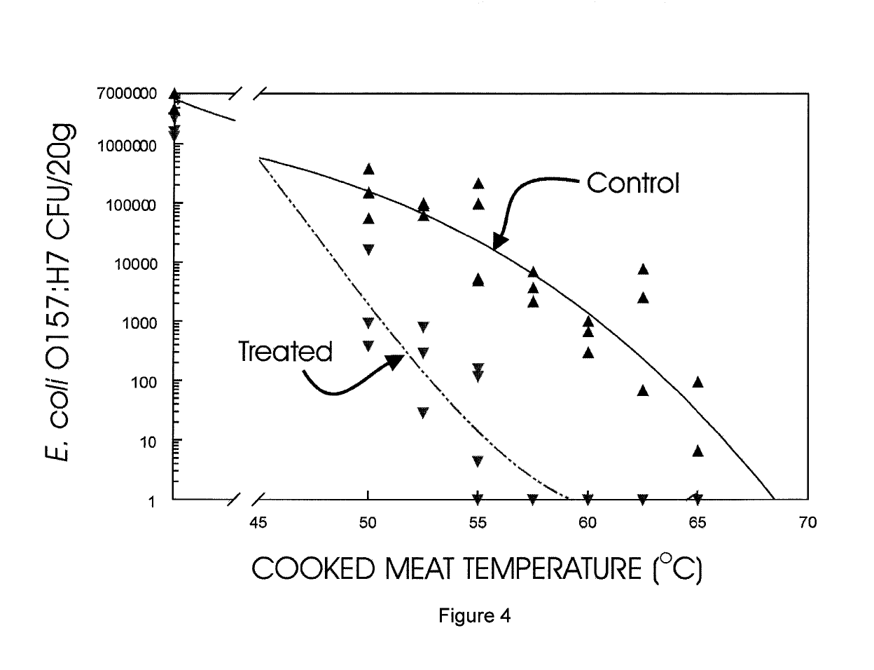

FIGS. 4 and 5 demonstrate the effects of acidulant Formula A and acidulant Formula B, respectively, on the survival of food borne pathogen in ground beef when the meat was cooked.

When Formula A was blended with ground beef (ground to about 3/32 inch, fat composition of about 20%), it can be seen from FIG. 4 that all E. coli 0157:H7 were killed at a temperature of about 57° C., whereas the control must be cooked to at least about 68° C. to achieve the same kill of the pathogens. Thus, effectively, the meat could be “undercooked” by about 10° C. and still would be safe to consume.

When acidulant Formula B (about 2.2 fold less concentrated than acidulant Formula A) was blended with ground beef (fat composition was about 24%, and a larger grind than above) it can be seen from FIG. 5 that all E. coli 0157:H7 were killed at a temperature of about 63° C., whereas the control must be cooked to at least about 68° C. to achieve the same kill of the pathogens. Here, the meat could be “undercooked” by about 5° C. and still would be safe to consume.

TABLE 1
Thermal inactivation of E. coli O157:H7 (OH1395) in ground beef
(24% fat) stored at 4° C.

| | | E. coli O157:H7 (log₁₀ CFU/g) at: | | | | |
|---|---|---|---|---|---|---|
| | | 0 | 5 | 10 | 15 | 20 |
| Temperature | Trial No. | (min) | | | | |
| 57° C. | 1 | 6.3 | 5.8 | 5.2 | 4.8 | 4.5 |
| | 2 | 6.0 | 4.2 | 3.8 | 2.9 | 2.0 |
| | | E. coli O157:H7 (log₁₀ CFU/g) at: | | | | |
| | | 0 | 2 | 5 | 10 | 15 |
| | | (min) | | | | |
| 60° C. | 1 | 6.1 | 5.1 | 3.6 | 3.0 | 1.7 |
| | 2 | 5.0 | 3.8 | 1.7 | <1.7 | <1.7 |

| | | E. coli O157:H7 (log₁₀ CFU/g) at: | | | | | |
|---|---|---|---|---|---|---|---|
| | | 0 | 1 | 3 | 5 | 7 | 9 |
| | | (min) | | | | | |
| 62.8° C. | 1 | 5.9 | 4.9 | 1.7 | <1.7 | <1.7 | <1.7 |
| | 2 | 4.0 | 1.7 | <1.7 | <1.7 | <1.7 | <1.7 |

| | | E. coli O157:H7 (log₁₀ CFU/g) at: | | | | |
|---|---|---|---|---|---|---|
| | | 0 | 0.5 | 0.75 | 1 | 1.25 |
| | | (min) | | | | |
| 64.3° C. | 1 | 3.9 | 3.3 | <1.7 | <1.7 | <1.7 |
| | 2 | 3.3 | 3.4 | <1.7 | <1.7 | <1.7 |

| E. coli O157:H7 (log₁₀ CFU/g) at: | | | | |
|---|---|---|---|---|
| 0 | 0.17 | 0.33 | 0.5 | 0.67 |

| | | (min) | | | | |
|---|---|---|---|---|---|---|
| 68.3° C. | 1 | 3.0 | 2.9 | <1.7 | <1.7 | <1.7 |
| | 2 | <1.7 | <1.7 | <1.7 | <1.7 | <1.7 |

TABLE 2
Thermal inactivation of E. coli O157:H7 (OH1395) in ground beef
(24% fat) containing ADDT and stored at 4° C.

| | | E. coli O157:H7 (log₁₀ CFU/g) at: | | | | |
|---|---|---|---|---|---|---|
| | | 0 | 5 | 10 | 15 | 20 |
| Temperature | Trial No. | (min) | | | | |
| 57° C. | 1 | 6.4 | 5.7 | 3.9 | 3.4 | 3.3 |
| | 2 | 6.2 | 3.2 | <1.7 | <1.7 | <1.7 |
| | | E. coli O157:H7 (log₁₀ CFU/g) at: | | | | |
| | | 0 | 2 | 5 | 10 | 16 |
| | | (min) | | | | |
| 60° C. | 1 | 6.1 | 2.4 | <1.7 | <1.7 | 1.7 |
| | 2 | 6.0 | <1.7 | <1.7 | <1.7 | <1.7 |

| | | E. coli O157:H7 (log₁₀ CFU/g) at: | | | | | |
|---|---|---|---|---|---|---|---|
| | | 0 | 1 | 3 | 5 | 7 | 9 |
| | | (min) | | | | | |
| 62.8° C. | 1 | 1.8 | 1.7 | <1.7 | <1.7 | <1.7 | <1.7 |
| | 2 | 2.5 | 2.0 | <1.7 | <1.7 | <1.7 | <1.7 |

| | | E. coli O157:H7 (log₁₀ CFU/g) at: | | | | |
|---|---|---|---|---|---|---|
| | | 0 | 0.5 | 0.75 | 1 | 1.25 |
| | | (min) | | | | |
| 64.3° C. | 1 | <1.7 | <1.7 | <1.7 | <1.7 | <1.7 |
| | 2 | <1.7 | <1.7 | <1.7 | <1.7 | <1.7 |
| | | E. coli O157:H7 (log₁₀ CFU/g) at: | | | | |
| | | 0 | 0.17 | 0.33 | 0.5 | 0.67 |
| | | (min) | | | | |
| 68.3° C. | 1 | <1.7 | <1.7 | <1.7 | <1.7 | <1.7 |
| | 2 | <1.7 | <1.7 | <1.7 | <1.7 | <1.7 |

TABLE 3
Thermal inactivation of E. coli O157:H7 (OH1395) in ground beef
(24% fat) stored at −20° C.

| | | E. coli O157:H7 (log₁₀ CFU/g) at: | | | | | |
|---|---|---|---|---|---|---|---|
| Temp- | | 0 | 1 | 3 | 5 | 10 | 15 |
| erature | Trial No. | (min) | | | | | |
| 57° C. | 1 | 6.2 | 6.1 | 5.9 | 5.6 | 5.0 | 3.8 |
| | 2 | 6.3 | 6.1 | 6.0 | 5.9 | 5.6 | 4.8 |
| | | E. coli O157:H7 (log₁₀ CFU/g) at: | | | | | |
| | | 0 | 0.5 | 1 | 2 | 5 | 10 |
| | | (min) | | | | | |
| 60° C. | 1 | 6.1 | 6.0 | 5.8 | 5.3 | 3.5 | <1.7 |
| | 2 | 5.8 | 5.6 | 5.5 | 4.8 | 3.3 | 1.7 |
| | | E. coli O157:H7 (log₁₀ CFU/g) at: | | | | | |
| | | 0 | 0.17 | 0.33 | 0.5 | 1 | 1.5 |
| | | (min) | | | | | |
| 62.8° C. | 1 | 6.1 | 5.5 | 4.9 | 4.2 | 2.1 | <1.7 |
| | 2 | 5.5 | 4.5 | 4.0 | 2.7 | <1.7 | <1.7 |
| | | E. coli O157:H7 (log₁₀ CFU/g) at: | | | | | |
| | | 0 | 0.17 | 0.33 | 0.5 | 0.67 | 1 |
| | | (min) | | | | | |
| 64.3° C. | 1 | 4.4 | 2.8 | <1.7 | <1.7 | <1.7 | <1.7 |
| | 2 | 4.3 | 2.9 | <1.7 | <1.7 | <1.7 | <1.7 |

| | | E. coli O157:H7 (log₁₀ CFU/g) at: | | | | | | |
|---|---|---|---|---|---|---|---|---|
| | | 0 | 0.17 | 0.33 | 0.5 | 0.67 | 0.83 | 1 |
| | | (min) | | | | | | |
| 68.3° C. | 1 | <1.7 | <1.7 | <1.7 | <1.7 | <1.7 | <1.7 | <1.7 |
| | 2 | <1.7 | <1.7 | <1.7 | <1.7 | <1.7 | <1.7 | <1.7 |

TABLE 4
Thermal inactivation of E. coli O157:H7 (OH1395) in ground beef
(24% fat) with ADDT and stored at −20° C.

| | | E. coli O157:H7 (log₁₀ CFU/g) at: | | | | | |
|---|---|---|---|---|---|---|---|
| Temp- | | 0 | 1 | 3 | 5 | 10 | 15 |
| erature | Trial No | (min) | | | | | |
| 57° C. | 1 | 6.2 | 6.0 | 5.8 | 4.7 | 2.6 | 2.0 |
| | 2 | 6.2 | 6.1 | 5.7 | 4.7 | 1.8 | <1.7 |
| | | E. coli O157:H7 (log₁₀ CFU/g) at: | | | | | |
| | | 0 | 0.5 | 1 | 2 | 5 | 10 |
| | | (min) | | | | | |
| 60° C. | 1 | 6.1 | 5.9 | 5.6 | 1.8 | <1.7 | <1.7 |
| | 2 | 5.0 | 3.2 | 1.7 | <1.7 | <1.7 | <1.7 |
| | | E. coli O157:H7 (log₁₀ CFU/g) at: | | | | | |
| | | 0 | 0.17 | 0.33 | 0.5 | 1 | 1.5 |
| | | (min) | | | | | |
| 62.8° C. | 1 | 6.0 | 5.1 | 4.4 | <1.7 | <1.7 | <1.7 |
| | 2 | 5.6 | 3.1 | 1.8 | <1.7 | <1.7 | <1.7 |
| | | E. coli O157:H7 (log₁₀ CFU/g) at: | | | | | |
| | | 0 | 0.17 | 0.34 | 0.5 | 0.67 | 1 |
| | | (min) | | | | | |
| 64.3° C. | 1 | 4.1 | <1.7 | <1.7 | <1.7 | <1.7 | <1.7 |
| | 2 | 4.0 | <1.7 | <1.7 | <1.7 | <1.7 | <1.7 |

| | | E. coli O157:H7 (log10 CFU/g) at: | | | | | | |
|---|---|---|---|---|---|---|---|---|
| | | 0 | 0.17 | 0.34 | 0.5 | 0.67 | 0.83 | 1 |
| | | (min) | | | | | | |
| 68.3° C. | 1 | <1.7 | <1.7 | <1.7 | <1.7 | <1.7 | <1.7 | <1.7 |
| | 2 | <1.7 | <1.7 | <1.7 | <1.7 | <1.7 | <1.7 | |

TABLE 5
D-values of E. coli O157:H7 in refrigerated or frozen ground beef
with and without ADDT

| Refrigerated or | D-value (min) at: | | | | |
|---|---|---|---|---|---|
| frozen | 57° C. | 60° C. | 62.8° C. | 64.3° C. | 68.3° C. |
| Refrigerated | 7.69 | 3.02 | 1.11 | 0.26 | ND |
| Refrigerated with | 5.26 | 0.96 | IS^{a} | ND^{b} | ND |
| ADDT | | | | | |
| Frozen | 5.71 | 2.07 | 0.29 | 0.24 | ND |
| Frozen with | 2.7 | 0.52 | 0.1 | IS | ND |
| ADDT | | | | | |

^{a}IS, insufficient number of data points to calculate D-value.
^{b}ND, no detectable E. coli O157:H7 at zero time (initial cell counts were ca. 10⁷ CFU/g before heating).

TABLE 6
Effect of Acidulant on the Replication of Salmonella typhimurium
Ground Beef

| | Incubation | Incubation Temperature(° C.) | | |
|---|---|---|---|---|
| Treatment | Time (hr) | 24° C. | 11° C. | 4° C. |
| Control | 0 | 1.0 × 10³ | 1.0 × 10³ | 1.0 × 10³ |
| Formula A | | 1.0 × 10³ | 1.0 × 10³ | 1.0 × 10³ |
| Formula B | | 9.4 × 10² | 9.4 × 10² | 9.4 × 10² |
| Control | 24 | 4.3 × 10 | 1.4 × 10³ | 8.1 × 10² |
| Formula A | | 1.6 × 10³ | 6.9 × 10² | 1.0 × 10² |
| Formula B | | 4.2 × 10⁵ | 5.1 × 10² | 8.1 × 10² |
| Control | 48 | 2.3 × 10⁸ | 8.2 × 10³ | 1.2 × 10³ |
| Formula A | | 2.5 × 10⁴ | 1.0 × 10³ | 8.8 × 10² |
| Formula B | | 2.9 × 10⁶ | 6.7 × 10² | 10.0 × 10² |
| Control | 12 | 5.8 × 10⁸* | 1.8 × 10⁴* | 8.7 × 10² |
| Formula A | | 7.8 × 10⁴ | 7.5 × 10² | 7.3 × 10² |
| Formula B | | 4.4 × 10⁶ | 1.8 × 10³ | 8.4 × 10² |
| Control | 96 | 4.2 × 10⁸* | 1.4 × 10⁵ | 8.5 × 10²* |
| Formula A | | 4.5 × 10⁶ | 7.8 × 10² | 5.9 × 10² |
| Formula B | | 1.1 × 10⁸ | 5.4 × 10³ | 6.9 × 10² |

*Besides Samonella colonies, numerous decay bacteria were present in the meat samples.

What is claimed is:

1. A method for increasing rate of thermal inactivation of a pathogen in a nutriment, comprising:
contacting the nutriment with an acidulant.

2. The method of claim 1, wherein the acidulant comprises: (a) an acidic, or low pH, solution of sparingly-soluble Group IIA complexes (“AGIIS”); (b) a highly acidic metalated mixture of inorganic acid (“HAMMIA”); (c) a highly acidic metalated organic acid (“HAMO”); (d) a mixture of the above; or (e) an adduct of each of the above.

3. The method of claim 1, wherein the nutriment comprises an animal product, a plant product, a beverage, or a mixture thereof.

4. A method for increasing rate of thermal inactivation of a pathogen in a nutriment, comprising:
contacting the nutriment with a solution or suspension of an acidic sparingly-soluble Group IIA complex (“AGIIS”), wherein the AGIIS is isolated from a mixture comprising a mineral acid and a Group IIA hydroxide, or a Group IIA salt of a dibasic acid, or a mixture of the two.

5. The method of claim 4, wherein the Group IIA hydroxide comprises calcium hydroxide, the mineral acid comprises sulfuric acid, and the Group IIA salt of a dibasic acid comprises calcium sulfate.

6. The method of claim 4, further comprising adding an additive to the AGIIS.

7. The method of claim 6, wherein the additive comprises an alcohol.

8. The method of claim 6, wherein the additive comprises an organic acid or an periodic acid.

9. The method of claim 6, wherein the additive comprises a surfactant.

10. The method of claim 4, wherein the nutriment comprises an animal product, a plant product, a beverage, or a mixture thereof.

11. The method of claim 4, wherein the nutriment comprises a meat product.

12. A method for increasing rate of thermal inactivation of pathogen in a nutriment comprising:
contacting a solution or suspension of an acidic sparingly-soluble Group IIA complex (“AGIIS”) with a carrier to give a constituted carrier, wherein the AGIIS is isolated from a mixture comprising a mineral acid and a Group IIA hydroxide, or a Group IIA salt of a dibasic acid, or a mixture of the two; and
blending the constituted carrier with the nutriment.

13. A method for increasing rate of thermal inactivation of pathogen in a nutriment comprising:
contacting a solution or suspension of an acidic sparingly-soluble Group IIA complex (“AGIIS”) with an additive and with a carrier to give a constituted carrier having the additive, wherein the AGIIS is isolated from a mixture comprising a mineral acid and a Group IIA hydroxide, or a Group IIA salt of a dibasic acid, or a mixture of the two; and
blending the nutriment with the constituted carrier having the additive.

14. A method for increasing rate of thermal inactivation of a pathogen in a nutriment comprising:
contacting a solution or suspension of a highly acidic metalated organic acid (“HAMO”) with the nutriment, wherein the solution or suspension of the HAMO is prepared by mixing ingredients comprising:
at least one regenerating acid having a first number of equivalents;
at least one metal base having a second number of equivalents; and
at least one organic acid; wherein the first number or equivalents of the regenerating acid is greater than that of the second number of equivalents of the metal base.

15. The method of claim 14, wherein the regenerating acid comprises a strong oxyacid of sulfur, phosphorus, nitrogen, chromium, or iodine.

16. The method of claim 14, wherein the regenerating acid comprises sulfuric acid, phosphoric acid, or an acidic solution of sparingly-soluble Group IIA complex (“AGIIS”).

17. The method of claim 14, further comprising adding an additive to the HAMO.

18. The method of claim 17, wherein the additive comprises an alcohol, an organic acid, a surfactant, a periodic acid, or a mixture thereof.

19. The method of claim 14, wherein the nutriment comprises an animal product, a plant product, a beverage, or a mixture thereof.

20. The method of claim 14, wherein the nutriment comprises a meat product.

21. A method for increasing rate of thermal inactivation of pathogen in a nutriment comprising:
contacting a solution or suspension of a highly acidic metalated organic acid (“HAMO”) with a carrier to give a constituted carrier, wherein the solution or suspension of the HAMO is prepared by mixing ingredients comprising:
at least one regenerating acid having a first number of equivalents;
at least one metal base having a second number of equivalents; and
at least one organic acid; wherein the first number or equivalents of the regenerating acid is greater than that of the second number of equivalents of the metal base; and
blending the constituted carrier with the nutriment.

22. A method for increasing rate of thermal inactivation of a pathogen in a nutriment, comprising:
contacting the nutriment with a solution or suspension of a highly acidic metalated mixture of inorganic acid (“HAMMIA”) having an acidic pH, wherein the HAMMIA is prepared by mixing ingredients comprising:
a salt of phosphoric acid; and
a preformed, or in-situ generated, solution or suspension of an acidic sparingly-soluble Group IIA complex (“AGIIS”), wherein the solution or suspension of AGIIS is in an amount in excess of the amount required to completely convert the salt of phosphoric acid to phosphoric acid and sufficient to render the acidic pH of the HAMMIA to be less than about 2.

23. The method of claim 22, wherein the solution or suspension of the AGIIS is isolated from a mixture comprising a mineral acid and a Group IIA hydroxide, or a Group IIA salt of a dibasic acid, or a mixture of the two.

24. The method of claim 22, wherein the Group IIA hydroxide comprises calcium hydroxide, the mineral acid comprises sulfuric acid and the Group IIA salt of a dibasic acid comprises calcium sulfate.

25. The method of claim 22, wherein the salt of phosphoric acid comprises a divalent metal salt of phosphoric acid.

26. The method of claim 22, wherein the divalent metal comprises an alkali earth metal or a metal of first transition series.

27. The method of claim 22, wherein the salt of phosphoric acid comprises a mono-valent metal salt of phosphoric acid.

28. The method of claim 22, wherein the mono-valent metal comprises an alkali metal.

29. The method of claim 22, further comprising adding an additive to the HAMMIA.

30. The method of claim 22, wherein the additive comprises an alcohol, an organic acid, a surfactant, a periodic acid, or a mixture thereof.

31. The method of claim 22, wherein the nutriment comprises an animal product, a plant product, a beverage, or a mixture thereof.

32. A method for increasing rate of thermal inactivation of pathogen in a nutriment comprising:
contacting a carrier with a solution or suspension of a HAMMIA having an acidic pH to give a constituted carrier, wherein the HAMMIA is prepared by mixing ingredients comprising:
a salt of phosphoric acid; and
a preformed, or in-situ generated, solution or suspension of an acidic sparingly-soluble Group IIA complex (“AGIIS”), wherein the solution or suspension of AGIIS is in an amount in excess of the amount required to completely convert the salt of phosphoric acid to phosphoric acid and sufficient to render the acidic pH of the HAMMIA to be less than about 2; and
blending the constituted carrier with the nutriment.

33. A method for increasing rate of thermal inactivation of a pathogen in a nutriment, comprising:
chilling the nutriment to give a chilled nutriment; and
contacting the chilled nutriment with an acidulant.

34. The method of claim 35, wherein the acidulant comprises: (a) an acidic, or low pH, solution of sparingly-soluble Group IIA complexes (“AGIIS”); (b) a highly acidic metalated mixture of inorganic acid (“HAMMIA”); (c) a highly acidic metalated organic acid (“HAMO”); (d) a mixture of the above; or (e) an adduct of each of the above.

35. The method of claim 35, wherein the nutriment comprises an animal product, a plant product, a beverage, or a mixture thereof.

36. The method of claim 35, wherein the chilled nutriment is a frozen nutriment.

37. A method for increasing rate of thermal inactivation of a pathogen in a nutriment, comprising:
contacting the nutriment with an acidulant to give a treated nutriment; and
chilling the treated nutriment.

38. The method of claim 37, wherein the acidulant comprises: (a) an acidic, or low pH, solution of sparingly-soluble Group IIA complexes (“AGIIS”); (b) a highly acidic metalated mixture of inorganic acid (“HAMMIA”); (c) a highly acidic metalated organic acid (“HAMO”); (d) a mixture of the above; or (e) an adduct of each of the above.

39. The method of claim 37, wherein the nutriment comprises an animal product, a plant product, a beverage, or a mixture thereof.

40. The method of claim 37, wherein the chilled nutriment is a frozen nutriment.

41. A method of extending case shelf-life of a nutriment, comprising:
contacting the nutriment with an acidulant.

42. The method of claim 41, wherein the acidulant comprises: (a) an acidic, or low pH, solution of sparingly-soluble Group IIA complexes (“AGIIS”); (b) a highly acidic metalated mixture of inorganic acid (“HAMMIA”); (c) a highly acidic metalated organic acid (“HAMO”); (d) a mixture of the above; or (e) an adduct of each of the above.

43. The method of claim 41, wherein the nutriment comprises an animal product, a plant product, a beverage, or a mixture thereof.
